(19) United States
(12) Patent Application Publication
(10) Pub. No.: US 2006/0211392 A1
(43) Pub. Date: Sep. 21, 2006

(54) Method for adjusting gain in radio receiver

(75) Inventor: Masaaki Suzuki, Kariya-shi (JP)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Kabushiki Kaisha Toyota Jidoshokki, Kariya-shi (JP)

(21) Appl. No.: 11/361,600

(22) Filed: Feb. 24, 2006

(30) Foreign Application Priority Data
Feb. 25, 2005 (JP) 2005-050804

(51) Int. Cl. H04B 1/06; H04B 7/00

(52) U.S. Cl. 455/253.2

(57) ABSTRACT

Each of variable gain amplifiers includes a P-side differential cell and an N-side differential cell, and the gains of the variable gain amplifiers are controlled depending on a difference between a P-side control current to control current flowing through the P-side differential cell and an N-side control current to control current flowing through the N-side differential cell. A plurality of gain data items are acquired for the variable gain amplifiers while varying the difference between the P-side control current and the N-side control current. A gain differential pattern between the variable gain amplifiers is obtained based on the acquired gain data. Based on the gain differential pattern, at least one of the P-side control current and the N-side control current of each of the variable gain amplifiers is varied.

### CROSS REFERENCE TO RELATED APPLICATIONS

This application claims priority to Japanese Patent Application No. 2005-050804, filed Feb. 25, 2005.

### FIELD OF THE INVENTION

The present invention relates to a method for adjusting a gain in a radio receiver, and, more specifically, to a method for adjusting a gain balance of an I channel and a Q channel.

### BACKGROUND OF THE INVENTION

A widely used type of a conventional radio receiver includes a variable gain amplifier for amplifying a received signal and a control circuit for controlling a gain of the variable gain amplifier. In the radio receiver having above configuration, the control circuit generally performs a feedback control so as to stabilize an amplitude of a signal output from the variable gain amplifier to be a desired level.

A technique is disclosed in JP-A-8-307174, in which variable gain amplifiers are provided for each of an I channel and a Q channel, which are obtained by separating a received signal. A gain of each of the variable gain amplifiers is properly controlled by a feedback control. Accordingly, a signal level balance between the I channel and the Q channel is adjusted.

When a difference in gain occurs between the I and Q channels due to production tolerance of variable gain amplifiers, errors may occur in a subsequent process circuit (for example, a baseband processor or the like). In addition, if a slope of a gain for an input voltage in the variable gain amplifier of the I channel is not equal to a slope of a gain for an input voltage in the variable gain amplifier of the Q channel, errors may occur likewise. Such a problem is likely to occur in a radio receiver employing, particularly, a direct conversion system.

In the configuration disclosed in the document JP-A-8-307174, the gains of I channel and Q channel are not separately adjusted. Accordingly, there is a limitation to adjustment precision of the gain balance between I channel and Q channel.

### SUMMARY OF THE INVENTION

The present invention provides a method for adjusting gains of I channel and Q channel (first and second differential signals) separately.

According to a first aspect of the present invention, there is provided a method for adjusting gains of first and second variable gain amplifiers that respectively amplifies first and second differential signals that are obtained by separating a received signal. Each of the first and second variable gain amplifiers includes a P-side differential cell and an N-side differential cell, the first and second variable gain amplifiers being configured that a gain of each of the first and second variable gain amplifiers is controlled in accordance with a difference between a P-side control current for controlling current flowing through the P-side differential cell and an N-side control current for controlling current flowing through the N-side differential cell. The method includes: acquiring a plurality of first gain data items for the first variable gain amplifier while varying the difference between the P-side control current and the N-side control current; acquiring a plurality of second gain data items for the second variable gain amplifier while varying the difference between the P-side control current and the N-side control current; obtaining a gain differential pattern between the first variable gain amplifier and the second variable gain amplifier based on the first gain data items and the second gain data items; and varying at least one of the P-side control current of the first variable gain amplifier, the N-side control current of the first variable gain amplifier, the P-side control current of the second variable gain amplifier, and the N-side control current of the second variable gain amplifier, based on the gain differential pattern.

According to a second aspect of the present invention, there is provided a method for adjusting a gain of a variable gain amplifier that amplifies a differential signal. Each of the variable gain amplifier includes a P-side differential cell and an N-side differential cell, the variable gain amplifier being configured that a gain of the variable gain amplifier is controlled in accordance with a difference between a P-side control current for controlling current flowing through the P-side differential cell and an N-side control current for controlling current flowing through the N-side differential cell. The method includes: acquiring a plurality of gain data items while varying the difference between the P-side control current and the N-side control current; obtaining a gain pattern based on the gain data items; and varying at least one of the P-side control current and the N-side control current, based on the gain pattern.

### BRIEF DESCRIPTION OF THE DRAWINGS

In the accompanying drawings:

FIG. 1 is a view showing a configuration of a radio receiver according to an embodiment;

FIG. 2 is a view showing a system for performing a gain adjusting method according to the embodiment;

FIG. 3 is a circuit diagram of a variable gain amplifier;

FIG. 4 is a view showing a configuration of a current controller provided in the gain controller;

FIGS. 5A and 5B are graphs showing an examples of the gain of the variable gain amplifier when a control voltage and a register setting value are varied;

FIGS. 6A and 6B are graphs showing another examples of the gain of the variable gain amplifier when the control voltage and the register setting value are varied;

FIGS. 7A and 7B are graphs showing still another examples of the gain of the variable gain amplifier when the control voltage and the register setting value are varied;

FIG. 8 is a flow chart showing an adjustment sequence according to the embodiment; and

FIGS. 9A-9H are views showing examples of a gain differential pattern.

### DETAILED DESCRIPTION OF ILLUSTRATIVE EMBODIMENTS

An embodiment of the present invention will be hereinafter described with reference to the accompanying drawings.

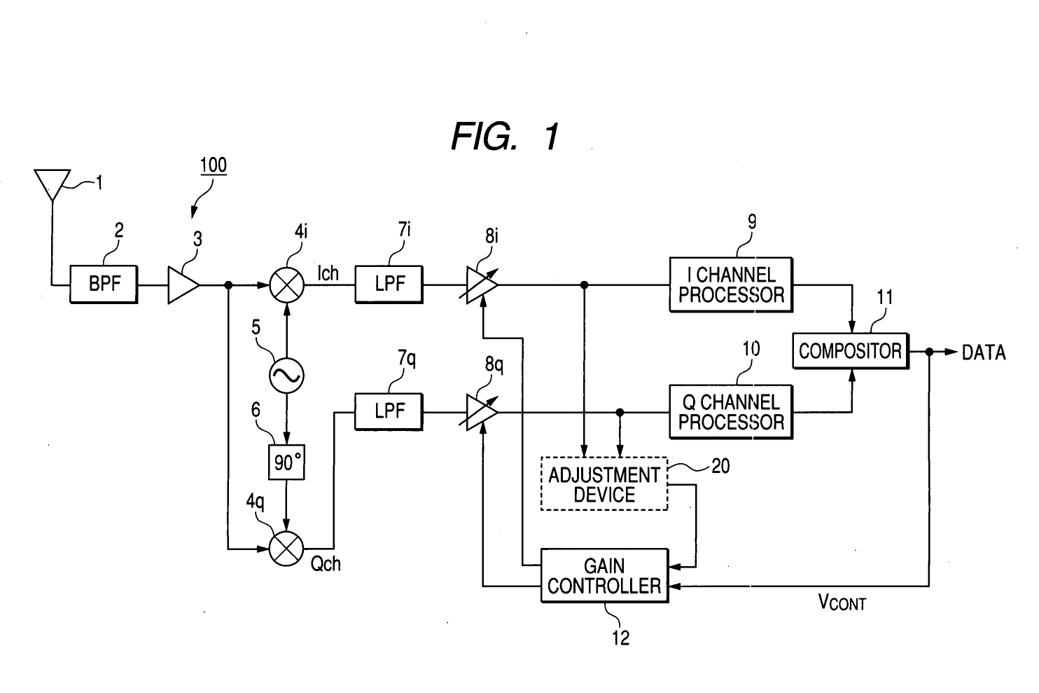

FIG. 1 is a view illustrating a configuration of a radio receiver according to the embodiment. In the following description, a radio receiver 100 employing a direct conversion system will be described. FIG. 1 shows a state where an adjustment device 20 according to the embodiment is connected to the radio receiver 100.

As shown in FIG. 1, a signal received by an antenna 1 is filtered in a band pass filter (BPF) 2 and then is amplified by a preamplifier 3. A multiplier 4i multiplies the received signal by an output of an oscillator 5. On the other hand, a multiplier 4q multiplies the received signal by a signal generated from a phase shifter 6 when the phase shifter 6 shifts a phase of the output of the oscillator 5 by 90 degrees. Here, the oscillation frequency of the oscillator 5 is the same as the carrier frequency of the radio signal. Accordingly, the outputs of the multipliers 4i and 4q are I channel and Q channel signals of a baseband, respectively. In the following description, the I channel signal and the Q channel signal are assumed as differential signals.

The I channel signal and the Q channel signal (first and second differential signals) are filtered in low pass filters (LPFs) 7i and 7q, respectively, and then are amplified by variable gain amplifiers 8i and 8q (first and second variable gain amplifiers). Here, the variable gain amplifiers 8i and 8q are differential amplifiers. An I channel processor 9 and a Q channel processor 10 obtain an I axis component and a Q axis component from the amplified I channel signal and Q channel signal, respectively. A compositor 11 reproduces transmitted data from outputs of the I channel processor 9 and the Q channel processor 10. A gain controller 12 controls gains of the variable gain amplifiers 8i and 8q with reference to an output (Vcont) of the compositor 11.

The gain adjusting method according to the embodiment as shown in FIG. 1 is to adjust the gains and/or gain balance of the I channel and Q channel of the variable gain amplifiers 8i and 8q using the adjustment device 20 before the radio receiver 100 is released into the market, in consideration of the likelihood that characteristics of the variable gain amplifiers 8i and 8q are not the same due to production tolerance of the components.

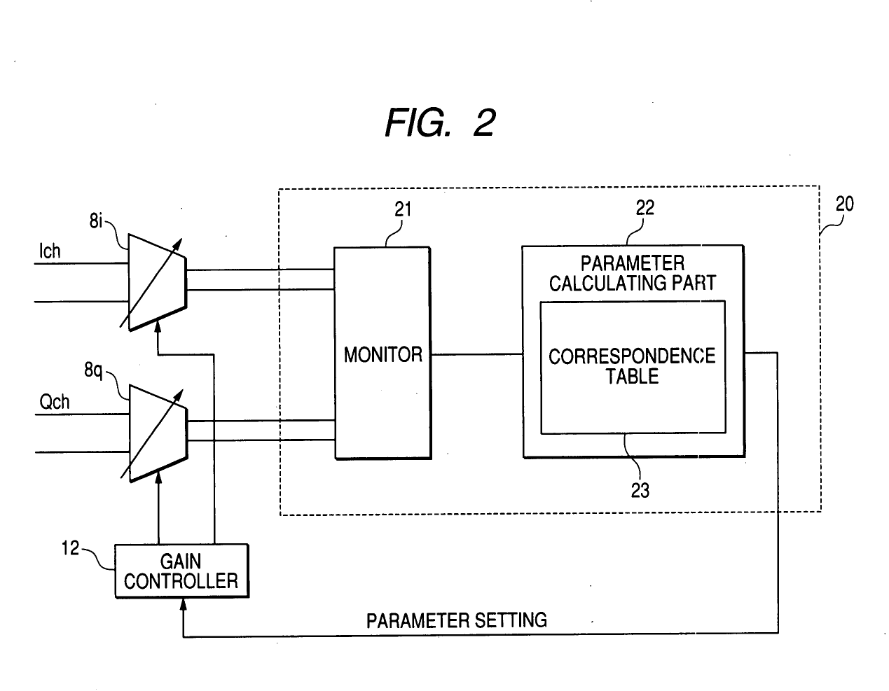

FIG. 2 is a view showing a system according to the embodiment for performing a gain adjusting method according to the invention. In this figure, the adjustment device 20 includes a monitor 21 and a parameter calculating part 22.

The monitor 21 detects amplitudes or power of the output signals of the variable gain amplifiers 8i and 8q (i.e., the amplified I channel/Q channel signals). The parameter calculating part 22 calculates the gains of the variable gain amplifiers 8i and 8q based on a result of the detection of the monitor 21. Here, it is assumed that the parameter calculating part 22 recognizes amplitudes or power of the input signals of the variable gain amplifiers 8i and 8q. In addition, the parameter calculating part 22 calculates parameters to be used to control the gains of the variable gain amplifiers 8i and 8q based on the calculated gains, and sets the parameters in the gain controller 12. Accordingly, the gains and/or gain balance of the variable gain amplifiers 8i and 8q are adjusted by the parameter calculating part 22. Detailed operation of the parameter calculating part 22 will be described later.

In this manner, the gain adjusting method according to the embodiment is performed by drawing the output signals of the variable gain amplifiers 8i and 8q out of the radio receiver 100 and setting the parameters calculated based on the drawn output signals in the gain controller 12.

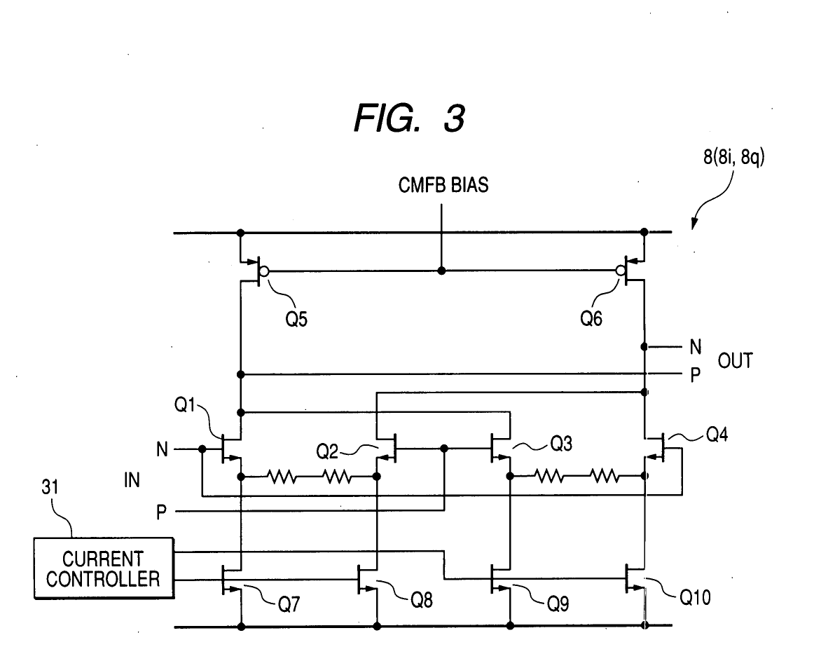

FIG. 3 is a circuit diagram of the variable gain amplifiers 8i and 8q. Since the variable gain amplifiers 8i and 8q have the same configuration, the variable gain amplifiers 8i and 8q will be collectively referred to as “a variable gain amplifier 8”. In addition, a positive-side signal and a negative-side signal composing differential signals amplified by the variable gain amplifier 8 will be hereinafter called a P signal and an N signal, respectively.

The variable gain amplifier 8 includes a P-side differential cell and an N-side differential cell. The P-side differential cell includes a set of transistors Q1 and Q2 and the N-side differential cell includes a set of transistors Q3 and Q4. Here, the P signal is applied to gates of the transistors Q2 and Q3 and the N signal is applied to gates of the transistors Q1 and Q4. In addition, sources of the transistors Q1 and Q2 are connected to each other via a resistor and sources of the transistors Q3 and Q4 are also connected to each other via a resistor. In addition, drains of the transistors Q1 and Q3 are connected to each other and drains of the transistors Q2 and Q4 are also connected to each other. In addition, a P signal outputting terminal is connected to the drains of the transistors Q1 and Q3 and an N signal outputting terminal is connected to the drains of the transistors Q2 and Q4.

A drain of a transistor Q5 is connected to the drains of the transistors Q1 and Q3 and a drain of a transistor Q6 is connected to the drains of the transistors Q2 and Q4. In addition, gates of the transistors Q5 and Q6 are applied with a feedback signal CMFB for holding a central voltage of the differential output (i.e., the P output and the N output) at a preset value.

Transistors Q7, Q8, Q9, and Q10 are connected to the sources of the transistors Q1, Q2, Q3, and Q4, respectively. In addition, a P-side control signal is applied to gates of the transistors Q7 and Q8 and an N-side control signal is applied to gates of the transistors Q9 and Q10. In addition, the P-side control signal and the N-side control signal are generated by a current controller 31, which will be described later.

The gain of the above-configured variable gain amplifier 8 is controlled by a difference between current flowing through the P-side differential cell (a P-side control current) and current flowing through the N-side differential cell (a N-side control current). Here, the P-side control current is controlled by the P-side control signal applied to the gates of the transistors Q7 and Q8 and the N-side control current is controlled by the n-side control signal applied to the gates of the transistors Q9 and Q10. That is, the gain of the variable gain amplifier 8 is controlled by the P-side control signal and the N-side control signal, which are generated by the current controller 31.

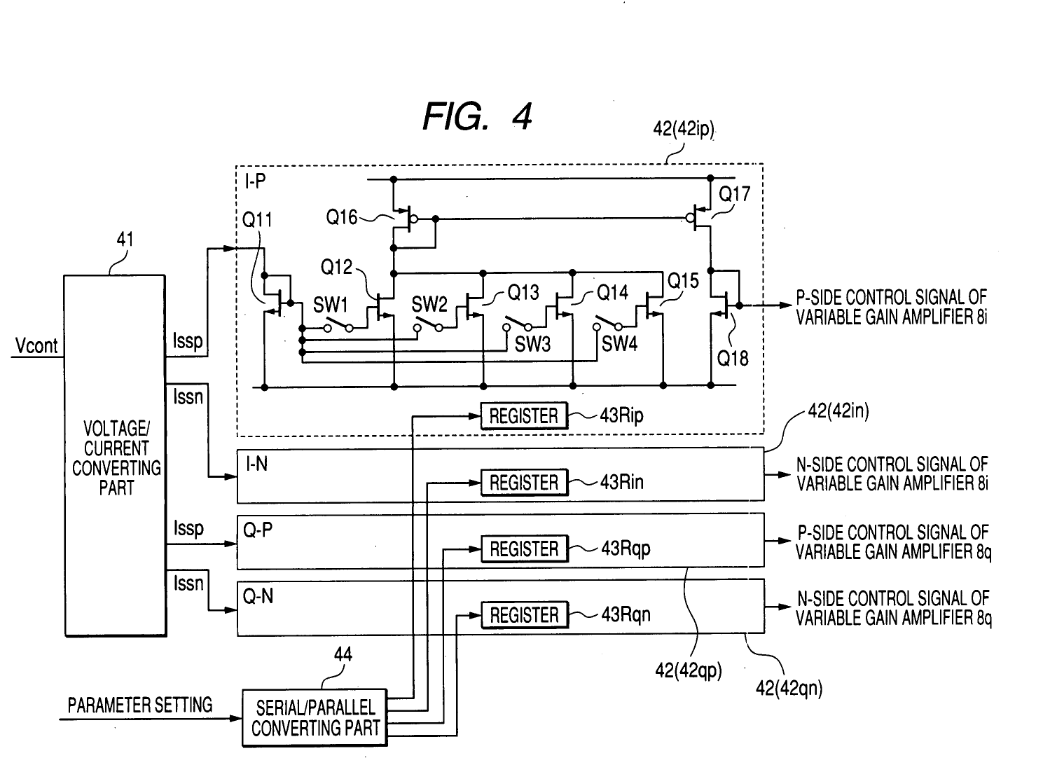

FIG. 4 is a view showing an embodiment of the current controller 31 provided in the gain controller 12. As described above with reference to FIG. 3, the current controller 31 generates the P-side control signal and the N-side control signal and applies them to the variable gain amplifier 8.

A voltage/current converting part 41 generates a control current Issp and a control current Issn from the control voltage Vcont. Here, the voltage/current converting part 41 generates the control current Issp and the control current Issn from the control voltage Vcont to satisfy, for example, the following relationship.
\sqrt{Vcont}=Issp−Issn

Four control signal generating parts 42 (42ip, 42in, 42qp, and 42qn) have the same configuration except that the control signal generating parts 42ip, 42in, 42qp, and 42qn include registers 43Rip, 43Rin, 43Rqp, and 43Rqn, respectively. Desired values (parameters) may be set in the registers 43Rip, 43Rin, 43Rqp, and 43Rqn, respectively, through a serial/parallel converting part 44. In addition, the control current Issp is supplied to the control signal generating parts 42ip and 42qp and the control current Issn is supplied to the control signal generating parts 42in and 42qn. In addition, the control signal generating part 42ip generates the P-side control signal to be supplied to the variable gain amplifier 8i, the control signal generating part 42 in generates the N-side control signal to be supplied to the variable gain amplifier 8i, the control signal generating part 42qp generates the P-side control signal to be supplied to the variable gain amplifier 8q, and the control signal generating part 42qn generates the N-side control signal to be supplied to the variable gain amplifier 8q. In the following description, operation of the control signal generating part 42ip will be described, and this operation is applied to the control signal generating parts 42in, 42qp, and 42qn in the same manner.

A transistor Q11 and transistors Q12 to Q15 configure a current mirror circuit. When current flowing through the transistor Q11 is assumed as ‘1’, currents flowing through the transistors Q12, Q13, Q14, and Q15 are ‘1’, ‘2’, ‘4’ and ‘8’, respectively. Switches SW1 to SW4 are provided at gates of the transistors Q12 to Q15, respectively. The ON/OFF of the switches SW1 to SW4 is controlled by a value set in the register 43Rip (a register setting value Rip). Here, a parameter calculated by the parameter calculating part 22 (in this example, any integer of 1 to 15. This parameter is hereinafter referred to as the register setting value Rip) is set in the register 43Rip. By varying the register setting value Rip between 1 and 15, all combinations with more than one of the switches SW1 to SW4 closed may be implemented. That is, current, which is one to fifteen times an input current (the control current Issp), may be generated by the register setting value Rip set in the register 43Rip.

Transistors Q16 and Q17 also configure a current mirror circuit. Accordingly, currents flowing through the transistors Q12 to Q1 are received in the transistor Q17. In addition, a transistor Q18 is connected to the transistor Q17. Accordingly, a voltage depending on the control current Issp and the register setting value Rip set in the register 43Rip is generated. This voltage is applied to the variable gain amplifier 8i as the P-side control signal.

In this manner, the gain controller 12 generates the P-side control signal and the N-side control signal corresponding to the register setting value Rip calculated by the parameter calculating part 22. The gains of the variable gain amplifiers 8i and 8q are controlled by the respective P-side control signal and N-side control signal, as described above with reference to FIG. 3. That is, the gains of the variable gain amplifiers 8i and 8q can be separately adjusted by the register setting value Rip calculated by the parameter calculating part 22.

Next, the gain adjusting method according to the embodiment will be described in more detail. In the gain adjusting method according to this embodiment, first, for a plurality of radio receivers, the gain of the variable gain amplifier 8 is monitored while varying the control voltage Vcont and parameters to be set in the registers 43Rip and 43Rin (hereinafter referred to as register setting values Rip and Rin). In addition, a correspondence among the control voltage Vcont, the parameters, and the gain is obtained in advance.

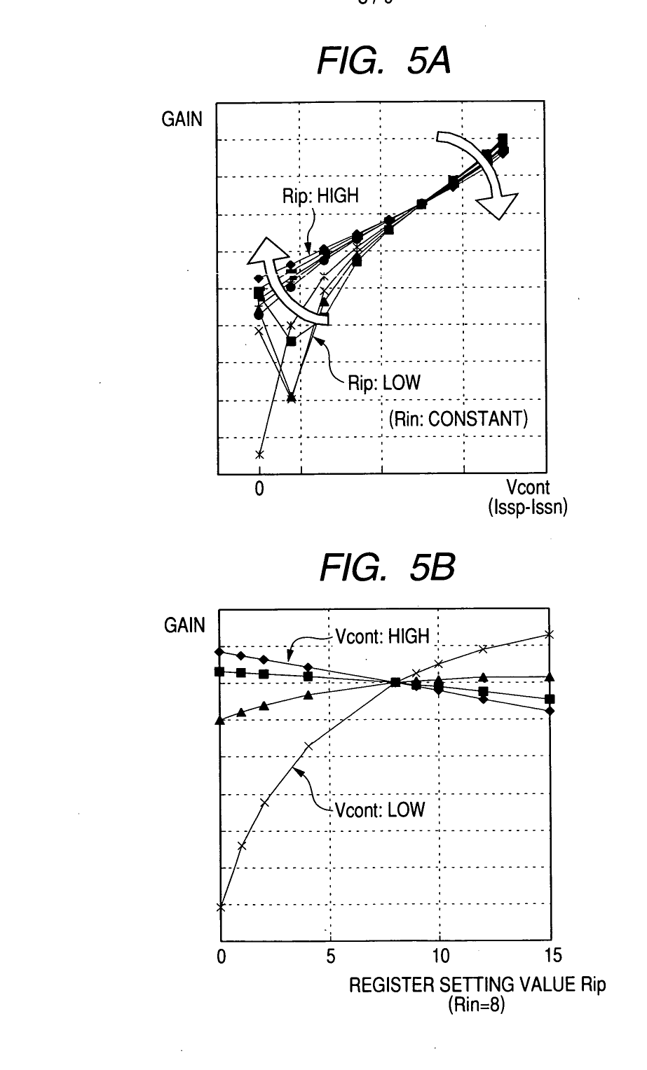

FIGS. 5A-7B are graphs showing examples of the gain of the variable gain amplifier 8i when the control voltage Vcont and the register setting values Rip and Rin are varied. Data shown in these figures are stored in a correspondence table 23, for example. The control voltage Vcont is varied in a range satisfying a relationship of “control current Issp≧control current Issn”. “Vcont=0” means “control current Issp=control current Issn”.

FIGS. 5A and 5B show a gain when the register setting value Rip for controlling the currents flowing through the transistors Q7 and Q8 connected to the P-side differential cell is varied while the register setting value Rin for controlling the currents flowing through the transistors Q9 and Q10 connected to the N-side differential cell is fixed. It can be seen from FIG. 5A that a gain curve of the variable gain amplifier 8 is rotated in a clockwise direction as the register setting value Rip increases. In addition, FIG. 5B is a graph provided to easily recognize the amount of variations of the gain when the register setting value Rip is varied.

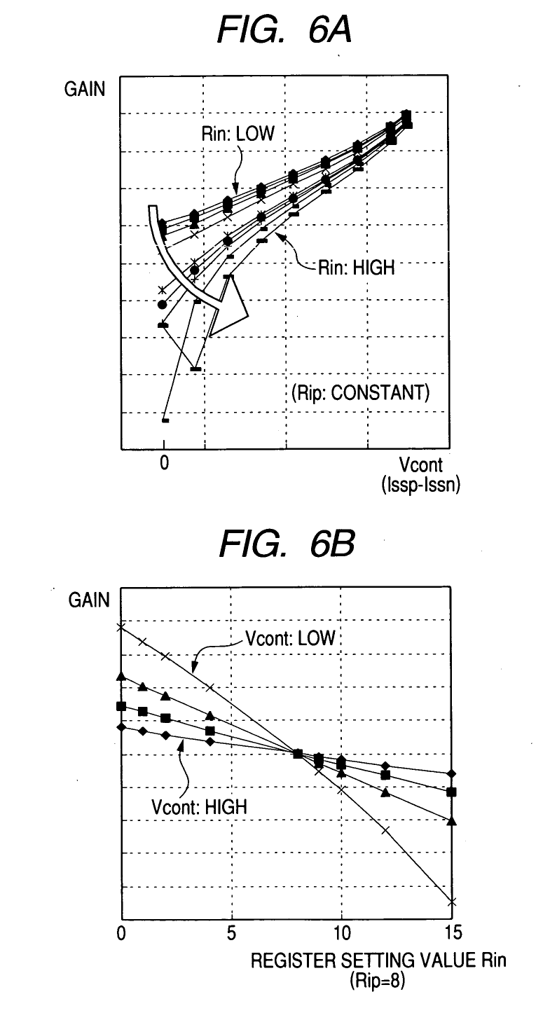

Contrary to FIGS. 5A and 5B, FIGS. 6A and 6B show a gain when the register setting value Rin is varied while the register setting value Rip is fixed. It can be seen from FIGS. 6A and 6B that a gain curve of the variable gain amplifier 8 is rotated in a counterclockwise direction as the register setting value Rin increases.

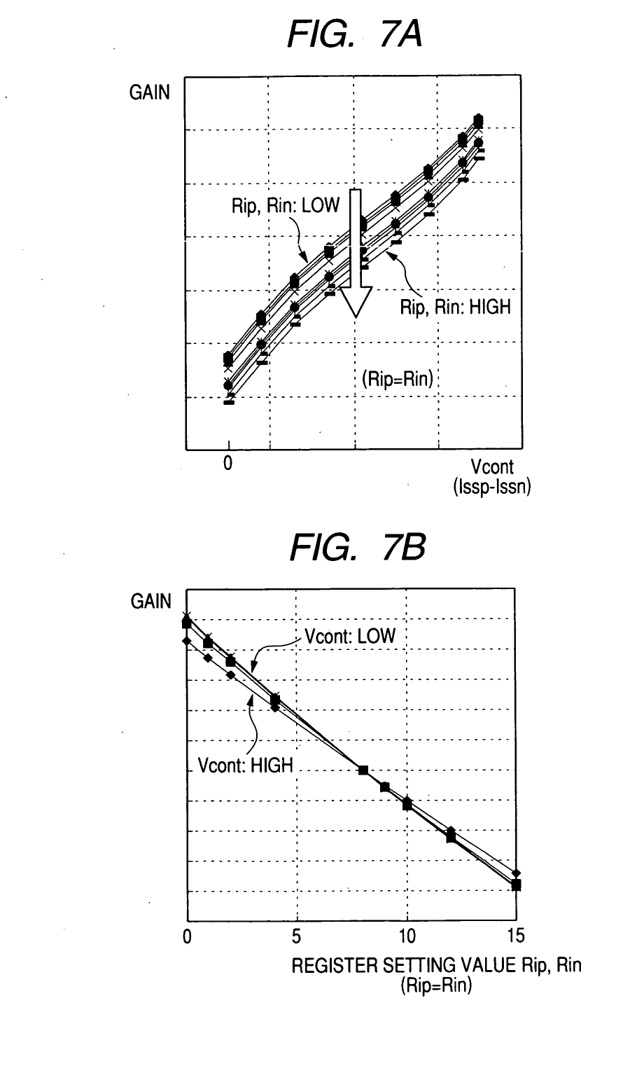

FIGS. 7A and 7B show a gain when the register setting value Rin and the register setting value Rip are varied while maintaining a relationship of ‘register setting value Rin=register setting value Rip’. It can be seen from FIGS. 7A and 7B that a gain curve of the variable gain amplifier 8 is moved in parallel for variations of the register setting values Rip and Rin.

In addition, as shown in FIGS. 5A, 6A and 7A, the gain of the variable gain amplifier 8 increases as the control voltage increases (that is, as a value of “control current Issp−control current Issn” increases).

In this manner, in the gain adjusting method according to the embodiment, the gain and the trend of variation of the gain curve of the variable gain amplifier 8 when at least one of the register setting value Rip and Rin is varied can be obtained in advance.

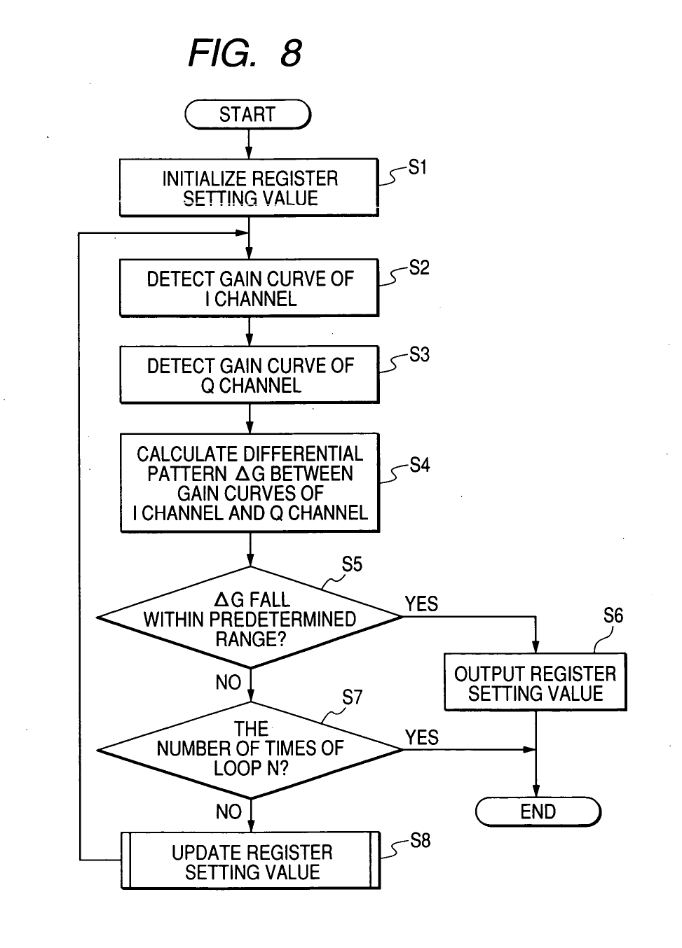

FIG. 8 is a flow chart showing a sequence of adjustment performed after the correspondence between the register setting value R and the gain characteristic of the variable gain amplifier 8 is obtained as described above. Processes in the flow chart are performed by the parameter calculating part 22.

In Step S1, all register setting values are initialized. In this embodiment, the register setting values to be set in the four registers 43Rip, 43Rin, 43Rqp, and 43Rqn (the register setting values Rip and Rin for the variable gain amplifier for 1 channel and the register setting values Rqp and Rqn for the variable gain amplifier for Q channel) are used. In addition, if the register setting value is assumed as one of values of 1 to 15, ‘8’ is set as an initial setting value, for example.

In Step S2, a gain curve of the variable gain amplifier 8 (8i) for I channel is detected. Specifically, gain data are acquired while varying the control voltage Vcont. In this example, gains Gi1 to Gi4 are detected by varying the control voltage Vcont four times. In Step S3, a gain curve of the variable gain amplifier 8 (8q) for Q channel is detected, as in Step S2. In this example, gains Gq1 to Gq4 are detected.

In Step S4, a gain differential pattern ΔG, which is a pattern of a difference between the gain curve of the I channel and the gain curve of the Q channel, is obtained. In this example, differences between the gains detected in Step S2 and the gains detected in Step S3, respectively, are calculated. That is, “ΔG1 (=Gi1−Gq1)”, “ΔG2 (=Gi2−Gq2)”, “ΔG3 (=Gi3−Gq3)”, and “ΔG4 (=Gi4−Gq4)” are obtained.

In Step S5, it is checked whether or not the gain differential pattern ΔG obtained in Step S4 is sufficiently small over an entire range of the control voltage Vcont (here, a variation range of the control voltage Vcont) so as to fall within a predetermined range with respect to zero (0) (reference pattern). If the gain differential pattern ΔG falls within the predetermined range, the register setting values (Rip, Rin, Rqp, and Rqn) at that time are output in Step S6, and then the adjustment process is ended. The output register setting values are set in the respective registers 43. In addition, the switches SW1 to SW4 are controlled by the register setting values set in the respective registers 43, at least one of the gain of the variable gain amplifier for I channel and the gain of the variable gain amplifier for Q channel is properly adjusted, and accordingly, the gain balance of the I channel/Q channel is secured.

If the gain differential pattern ΔG do not falls within the predetermined range, the number of times of execution of a loop process of Steps S1 to S6 is checked in Step S7. If the number of times of execution reaches a predetermined number N, an error message is output and then the adjustment process is ended.

In Step S8, the register setting values are updated according to the gain differential pattern ΔG. Thereafter, the adjustment process returns to Step S2. In addition, in Step S8, at least one of the four register setting values (Rip, Rin, Rqp, and Rqn) is updated. This means varying at least one of the P-side control current of the variable gain amplifier for I channel, the N-side control current of the variable gain amplifier for I channel, the P-side control current of the variable gain amplifier for Q channel, and the N-side control current of the variable gain amplifier for Q channel. Detailed examples of Step S8 will be hereinafter described.

(a) A Case where a Gain of I Channel is Small Over the Entire Range of the Control Voltage Vcont

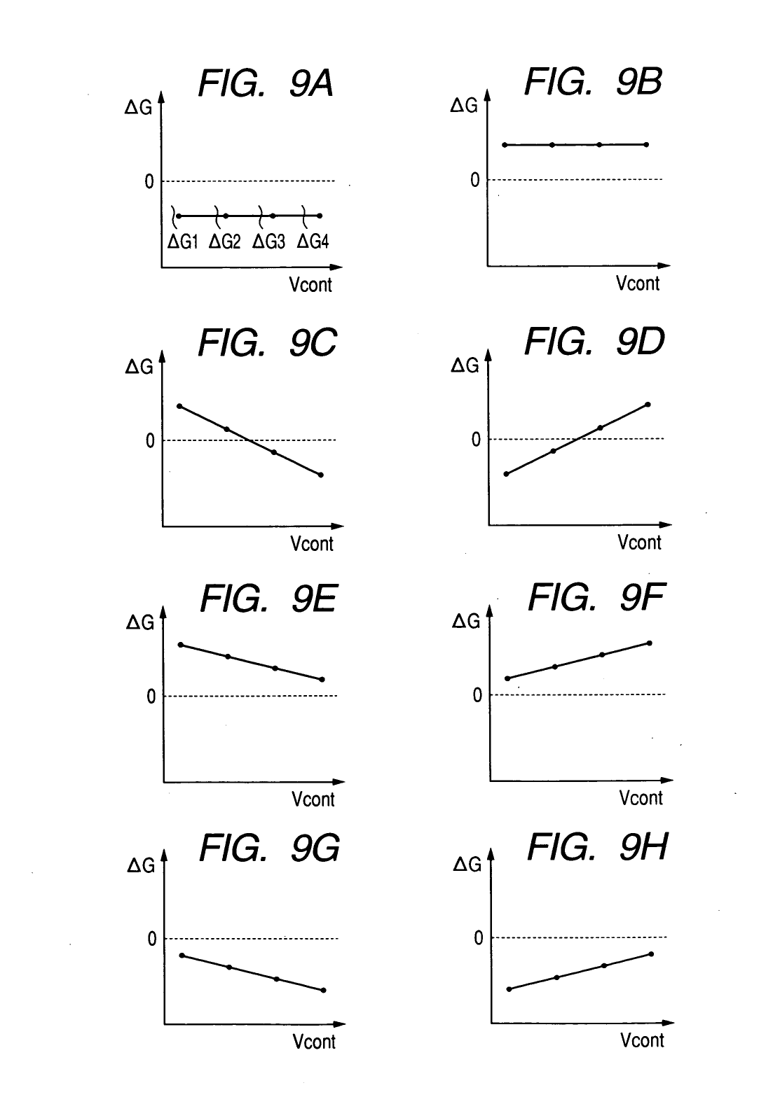

The case (a) corresponds to a case where all of ΔG1 to ΔG4 have a negative value, for example, as shown in FIG. 9A. In this case, in order to make a difference in gain between I channel and Q channel small, the gain differential pattern ΔG may be upward moved in parallel in FIG. 9A. That is, for example, the gain of the variable gain amplifier for I channel is made large over the entire range of the control voltage Vcont. Accordingly, in this case, the register setting values Rip and Rin for the variable gain amplifier 8i for I channel are increased by the same value by using the method shown in FIGS. 7A and 7B.

(b) A Case where a Gain of I Channel is Large Over the Entire Range of the Control Voltage Vcont

The case (b) corresponds to a case where all of ΔG1 to ΔG4 have a positive value, for example, as shown in FIG. 9B. In this case, in order to make a difference in gain between the I channel and the Q channel small, the gain differential pattern ΔG may be downward moved in parallel in FIG. 9B. That is, for example, the gain of the variable gain amplifier for I channel is made small over the entire range of the control voltage Vcont. Accordingly, in this case, the register setting values Rip and Rin for the variable gain amplifier 8i for I channel are decreased by the same value by using the method shown in FIGS. 7A and 7B.

(c) A First Case where the Gain Differential Pattern ΔG is Inclined (as Shown in FIG. 9C, Case where the Gain Differential Pattern ΔG Decreases from a Positive Value to a Negative value as the Control Voltage Vcont Increases)

In the case (c) as shown in FIG. 9C, the gain of the I channel is larger than the gain of the Q channel in a small gain (Vcont) region and the gain of the Q channel is larger than the gain of the I channel in a large gain (Vcont) region. In this case, in order to make the difference in gain between the I channel and the Q channel small, the gain differential pattern ΔG may be rotated in a counterclockwise direction in FIG. 9C. Accordingly, in this case, for example, the register setting value Rip for varying the P-side control signal of the variable gain amplifier 8i for I channel is decreased by a preset value by using the method shown in FIGS. 5A and 5B. Or, the register setting value Rin for varying the N-side control signal of the variable gain amplifier 8i for I channel may be increased by a preset value by using the method shown in FIGS. 6A and 6B.

(d) A Second Case where the Gain Differential Pattern ΔG is Inclined (as Shown in FIG. 9D, Case where the Gain Differential Pattern ΔG Increases from a Negative Value to a Positive Value as the Control Voltage Vcont Increases)

In the case (d) as shown in FIG. 9D, the gain of the Q channel is larger than the gain of the I channel in a small gain (Vcont) region and the gain of the I channel is larger than the gain of the Q channel in a large gain (Vcont) region. In this case, in order to make the difference in gain between the I channel and the Q channel small, the gain differential pattern ΔG may be rotated in a clockwise direction in FIG. 9D. Accordingly, in this case, for example, the register setting value Rip for varying the P-side control signal of the variable gain amplifier 8i for I channel is increased by a preset value by using the method shown in FIGS. 5A and 5B. Otherwise, the register setting value Rin for varying the N-side control signal of the variable gain amplifier 8i for I channel may be decreased by a preset value by using the method shown in FIGS. 6A and 6B.

In cases as such shown in FIGS. 9E to 9H, the gain balance may be adjusted by combining the above-described ‘parallel movement’ and ‘rotation’. FIG. 9E shows a case where the gain differential pattern ΔG decreases in a positive region as the control voltage Vcont increases. In FIG. 9E, a proper gain balance can be obtained by combining a downward parallel movement and a counterclockwise rotation. FIG. 9F shows a case where the gain differential pattern ΔG increases in the positive region as the control voltage Vcont increases. In FIG. 9F, a proper gain balance can be obtained by combining the downward parallel movement and a clockwise rotation. FIG. 9G shows a case where the gain differential pattern ΔG decreases in a negative region as the control voltage Vcont increases. In FIG. 9G, a proper gain balance can be obtained by combining an upward parallel movement and a counterclockwise rotation. FIG. 9H shows a case where the gain differential pattern ΔG increases in the negative region as the control voltage Vcont increases. In FIG. 9H, a proper gain balance can be obtained by combining an upward parallel movement and a clockwise rotation.

Although the gain balance is adjusted by updating at least one of the register setting values Rip and Rin for the variable gain amplifier 8i for I channel in the above embodiment shown in FIGS. 9A to 9H, since the variable gain amplifiers 8i and 8q have the same configuration in this embodiment, at least one of the register setting values Rqp and Rqn for the variable gain amplifier 8q for Q channel may be updated. However, if the variable gain amplifiers 8i and 8q have different characteristics, a correspondence between the control voltage Vcont and the register setting values must be obtained in advance, and, based on the obtained correspondence, the register setting values for the variable gain amplifiers 8i and 8q must be updated.

In addition, each variable gain amplifier 8 is a single amplifier in the above embodiment, but it may be configured by connecting a plurality of amplifiers in a multistage manner. In this case, each amplifier may be adjusted in the above-mentioned sequence.

In addition, even though it is illustrated in the above embodiment that the gain differential patterns of the I/Q channels are obtained in advance, and then, the gain differential patterns approach ‘0’, the invention is not limited to this. For example, the invention may be applied to a method of approaching the gain pattern of the I channel and the gain pattern of the Q channel to ideal gain patterns.

As describe in detail with reference to the embodiment, according to a first aspect, there is provided a method for adjusting gains of first and second variable gain amplifiers that respectively amplifies first and second differential signals that are obtained by separating a received signal. Each of the first and second variable gain amplifiers includes a P-side differential cell and an N-side differential cell, the first and second variable gain amplifiers being configured that a gain of each of the first and second variable gain amplifiers is controlled in accordance with a difference between a P-side control current for controlling current flowing through the P-side differential cell and an N-side control current for controlling current flowing through the N-side differential cell. The method includes: acquiring a plurality of first gain data items for the first variable gain amplifier while varying the difference between the P-side control current and the N-side control current; acquiring a plurality of second gain data items for the second variable gain amplifier while varying the difference between the P-side control current and the N-side control current; obtaining a gain differential pattern between the first variable gain amplifier and the second variable gain amplifier based on the first gain data items and the second gain data items; and varying at least one of the P-side control current of the first variable gain amplifier, the N-side control current of the first variable gain amplifier, the P-side control current of the second variable gain amplifier, and the N-side control current of the second variable gain amplifier, based on the gain differential pattern.

According to the method configured as above, the gain differential pattern between the first variable gain amplifier and the second variable gain amplifier is obtained. The gains of the first variable gain amplifier and/or the second variable gain amplifier are separately adjusted by controlling the P-side control current and/or the N-side control current of the first variable gain amplifier and/or the second variable gain amplifier, based on the gain differential pattern.

In the method, there may be configured that the acquiring of the first gain data items, the acquiring of the second data items, the obtaining of the gain differential pattern, and the varying of at least one of the control currents, are repeatedly performed until the gain differential pattern is adjusted to fall within a predetermined range of a preset reference pattern. According to this configuration, the gain balance between the first variable gain amplifier and the second variable gain amplifier can be reliably adjusted.

In the method, there may be configured that the method further includes preliminarily obtaining a correspondence between parameters for controlling the P-side control current and the N-side control current of the first variable gain amplifier and a gain pattern obtained when the difference between the P-side control current and the N-side control current is varied in the first variable gain amplifier, and configured that, when varying at least one of the control currents, at least one of the P-side control current of the first variable gain amplifier and the N-side control current of the first variable gain amplifier is varied by varying a corresponding parameter using the correspondence preliminarily obtained. According to this configuration, efficiency of operation of adjusting a plurality of amplifiers can be improved by using the average correspondence obtained in advance.

According to a second aspect, there is provided a method for adjusting a gain of a variable gain amplifier that amplifies a differential signal. The variable gain amplifier includes a P-side differential cell and an N-side differential cell, the variable gain amplifier being configured that a gain of the variable gain amplifier is controlled in accordance with a difference between a P-side control current for controlling current flowing through the P-side differential cell and an N-side control current for controlling current flowing through the N-side differential cell. The method includes: acquiring a plurality of gain data items while varying the difference between the P-side control current and the N-side control current; obtaining a gain pattern based on the gain data items; and varying at least one of the P-side control current and the N-side control current, based on the gain pattern.

According to the method configured as above, the method may be applied to adjustment of gains of a plurality of separate variable gain amplifiers as well as adjustment of the gain balance of a set of variable gain amplifiers.

According to the present invention, since gains are adjusted for each channel based on the gain differential pattern or the gain pattern, the gains of the I channel and the Q channel (first and second differential signals) can be adjusted separately.

Although the present invention has been shown and described with reference to an embodiment, various changes and modifications will be apparent to those skilled in the art from the teachings herein. Such changes and modifications as are obvious are deemed to come within the spirit, scope and contemplation of the invention as defined in the appended claims.

What is claimed:

1. A method for adjusting gains of first and second variable gain amplifiers that respectively amplifies first and second differential signals that are obtained by separating a received signal,
wherein each of the first and second variable gain amplifiers includes a P-side differential cell and an N-side differential cell, the first and second variable gain amplifiers being configured that a gain of each of the first and second variable gain amplifiers is controlled in accordance with a difference between a P-side control current for controlling current flowing through the P-side differential cell and an N-side control current for controlling current flowing through the N-side differential cell, and
wherein the method comprises:
acquiring a plurality of first gain data items for the first variable gain amplifier while varying the difference between the P-side control current and the N-side control current;
acquiring a plurality of second gain data items for the second variable gain amplifier while varying the difference between the P-side control current and the N-side control current;
obtaining a gain differential pattern between the first variable gain amplifier and the second variable gain amplifier based on the first gain data items and the second gain data items; and
varying at least one of the P-side control current of the first variable gain amplifier, the N-side control current of the first variable gain amplifier, the P-side control current of the second variable gain amplifier, and the N-side control current of the second variable gain amplifier, based on the gain differential pattern.

2. The method according to claim 1, wherein the acquiring of the first gain data items, the acquiring of the second data items, the obtaining of the gain differential pattern, and the varying of at least one of the control currents, are repeatedly performed until the gain differential pattern is adjusted to fall within a predetermined range of a preset reference pattern.

3. The method according to claim 1 further comprising preliminarily obtaining a correspondence between parameters for controlling the P-side control current and the N-side control current of the first variable gain amplifier and a gain pattern obtained when the difference between the P-side control current and the N-side control current is varied in the first variable gain amplifier,
wherein when varying at least one of the control currents, at least one of the P-side control current of the first variable gain amplifier and the N-side control current of the first variable gain amplifier is varied by varying a corresponding parameter using the correspondence preliminarily obtained.

4. A method for adjusting a gain of a variable gain amplifier that amplifies a differential signal,
wherein the variable gain amplifier includes a P-side differential cell and an N-side differential cell, the variable gain amplifier being configured that a gain of the variable gain amplifier is controlled in accordance with a difference between a P-side control current for controlling current flowing through the P-side differential cell and an N-side control current for controlling current flowing through the N-side differential cell, and
wherein the method comprises:
acquiring a plurality of gain data items while varying the difference between the P-side control current and the N-side control current;
obtaining a gain pattern based on the gain data items; and
varying at least one of the P-side control current and the N-side control current, based on the gain pattern.
